(19) United States
(12) Patent Application Publication
(10) Pub. No.: US 2013/0151837 A1
(43) Pub. Date: Jun. 13, 2013

(54) APPLICATION MANAGEMENT OF A PROCESSOR PERFORMANCE MONITOR

(71) Applicants: Giles R. Frazier, Austin, TX (US); Venkat R. Indukuru, Austin, TX (US)

(72) Inventors: Giles R. Frazier, Austin, TX (US); Venkat R. Indukuru, Austin, TX (US)

(73) Assignee: INTERNATIONAL BUSINESS MACHINES CORPORATION, Armonk, NY (US)

(21) Appl. No.: 13/315,407

(22) Filed: Dec. 9, 2011

(51) Int. Cl. G06F 9/00

(52) U.S. Cl. 713/100

(57) ABSTRACT

A method, system or computer usable program product for an operating system (OS) enabling an application direct control of a performance monitoring unit (PMU) including enabling the PMU to notify the application when a PMU exception occurs without interrupting the OS by controllably encoding a redirect field in an OS accessible control register, and enabling the application to reinitialize the PMU after the PMU exception.

### BACKGROUND

1. Technical Field

The present invention relates generally to managing a processor performance monitoring facility, and in particular, to a computer implemented method for direct application access to a processor performance monitoring facility.

2. Description of Related Art

Many processors have a performance monitoring facility built into the hardware for tracking various performance characteristics such as instructions executed, cache misses, processor stalls and other performance related events. This performance monitoring facility is highly secure and may be accessible by an operating system under a privileged execution level. This operating system may utilize this access to assist in determining the performance of the processor under certain conditions.

The operating system may provide such performance information to certain software applications upon demand such as by system calls or other signals. However, due to the secure nature of the information, the operating system will only provide such performance information to an application so long as the security of that information is maintained. For example, an operating system should not provide performance information of a processor when it is being utilized by one application to a different application.

Some applications such as just in time compilers may utilize processor performance information extensively. For example, a compiler would find it useful to know how often events such as cache misses or instruction retries delays processing. However, the act of querying the operating system for such processor events also causes delays due to the processing of the request.

### SUMMARY

The illustrative embodiments provide a method, system, and computer usable program product for an operating system (OS) enabling an application direct control of a performance monitoring unit (PMU) including enabling the PMU to notify the application when a PMU exception occurs without interrupting the OS by controllably encoding a redirect field in an OS accessible control register, and enabling the application to reinitialize the PMU after the PMU exception.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of a data processing system in which various embodiments may be implemented;

FIG. 2 is a block diagram of a network of data processing systems in which various embodiments may be implemented;

FIG. 3 is a block diagram illustrating hardware facilities in a processor in which various embodiments of the invention may be implemented;

FIG. 4A is a flowchart showing the actions of an operating system in response to a request from a software application to gain access to the PMU and related counters and registers in accordance with a preferred embodiment;

FIG. 4B is a flowchart showing the actions of a software application requesting access to the PMU and related counters and registers in accordance with the preferred embodiment; and

FIG. 5 is a flowchart of the handling of an asynchronous event in accordance with the preferred embodiment.

### DETAILED DESCRIPTION

Steps may be taken to provide applications direct access to the processor performance facility while maintaining security. These steps may be taken as will be explained with reference to the various embodiments below.

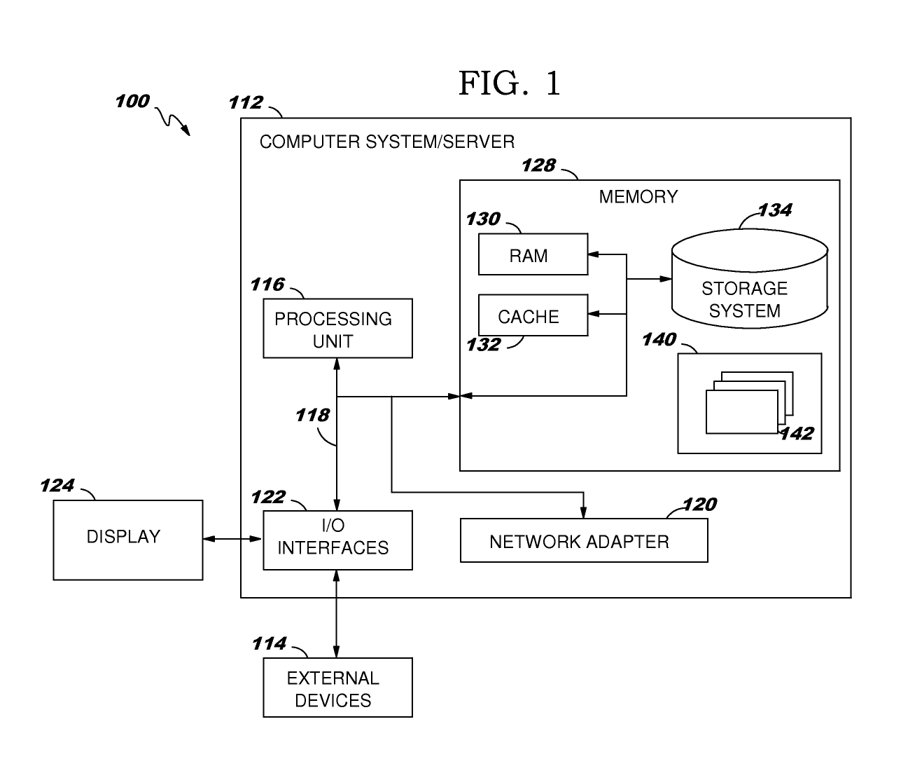

FIG. 1 is a block diagram of a data processing system in which various embodiments may be implemented. Data processing system 100 is only one example of a suitable data processing system and is not intended to suggest any limitation as to the scope of use or functionality of embodiments of the invention described herein. Regardless, data processing system 100 is capable of being implemented and/or performing any of the functionality set forth herein.

In data processing system 100 there is a computer system/server 112, which is operational with numerous other general purpose or special purpose computing system environments or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer system readable media. Such media may be any available media that is accessible by computer system/server 112, and it includes both volatile and non-volatile media, removable and non-removable media.

System memory 128 can include computer system readable media in the form of volatile memory, such as random access memory (RAM) 130 and/or cache memory 132. Computer system/server 112 may further include other removable/non-removable, volatile/non-volatile computer system storage media. By way of example only, storage system 134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of embodiments of the invention. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of embodiments of the invention.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, redundant processing units, external disk drive arrays, RAID systems, tape drives, and data archival storage systems, etc.

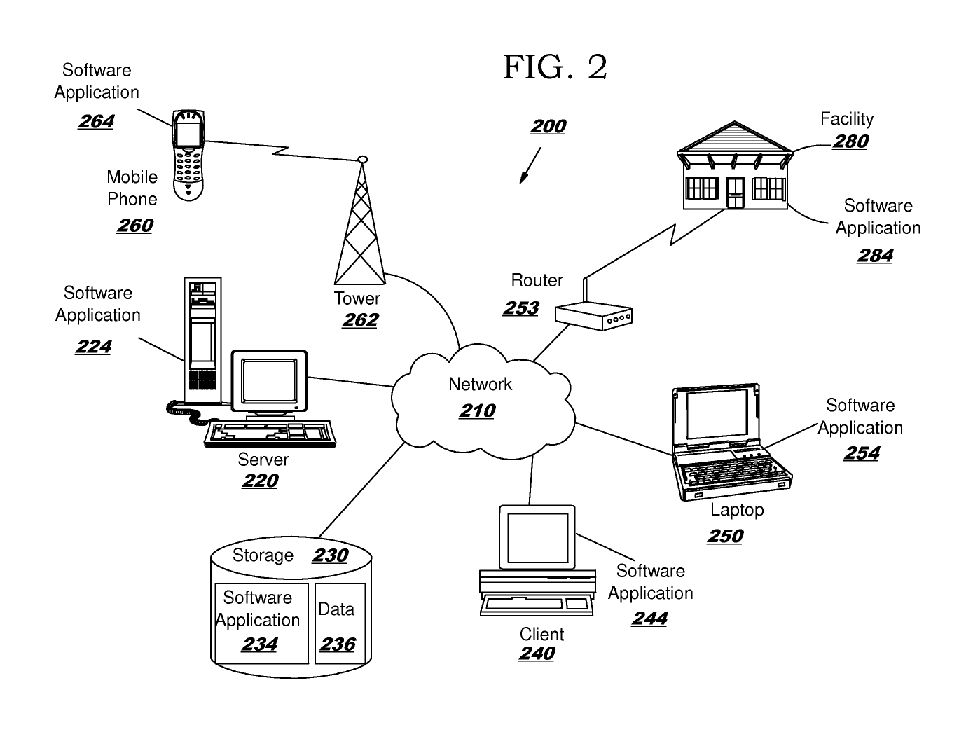

FIG. 2 is a block diagram of a network of data processing systems in which various embodiments may be implemented. Data processing environment 200 is a network of data processing systems such as described above with reference to FIG. 1. Software applications may execute on any computer or other type of data processing system in data processing environment 200. Data processing environment 200 includes network 210. Network 210 is the medium used to provide communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile phone 260 may be coupled to network 210 through a mobile phone tower 262. Data processing systems, such as server 120, client 140, laptop 150, mobile phone 160 and facility 180 contain data and have software applications including software tools executing thereon. Other types of data processing systems such as personal digital assistants (PDAs), smartphones, tablets and netbooks may be coupled to network 210.

Server 220 may include software application 224 such as for accessing a processor performance monitor or other software applications in accordance with embodiments described herein. Storage 230 may contain software application 234 and a content source such as data 236 such as performance data for use by the software application or for use by a compiler or other software to improve performance of the software application. Other software and content may be stored on storage 230 for sharing among various computer or other data processing devices. Client 240 may include software application 244. Laptop 250 and mobile phone 260 may also include software applications 254 and 264. Facility 280 may include software applications 284. Other types of data processing systems coupled to network 210 may also include software applications. Software applications could include a web browser, email, or other software application that can process sensor and maintenance information of an environmental control unit or other type of information to be processed.

Server 220, storage unit 230, client 240, laptop 250, mobile phone 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Client 240 and laptop 250 may be clients to server 220 in this example. Client 240, laptop 250, mobile phone 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

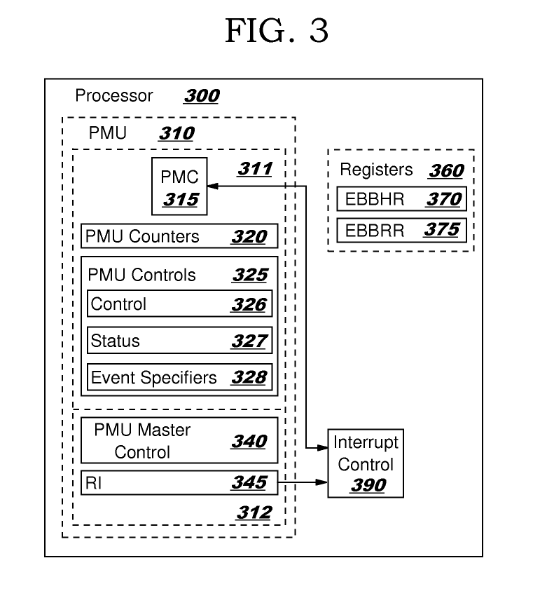

FIG. 3 is a block diagram illustrating hardware facilities in a processor in which various embodiments of the invention may be implemented. Alternative hardware facilities may be implemented in alternative embodiments. That is, the hardware shown may be located elsewhere in the processor and other types of hardware may be utilized.

Processor 300 may include a variety of hardware including a CPU, cache(s), input and output units, etc. Processor 300 also includes a processor monitoring unit (PMU) 310 for monitoring the performance of the processor during operation. PMU 310 includes two sections, shared section 311 and highly secure section 312. The entire shared section 311 is accessible by the operating system. All or part of shared section 311 is also accessible to applications that have been given permission for such access by the operating system. Highly secure section 312 is only accessible by an operating system for managing software application access to the shared section.

Shared section 311 includes processor monitoring circuitry (PMC) 315, PMU counters 320, and other PMU controls 325. PMC 315 monitors the performance of a processor, provides information about that performance in various registers as will be described herein, and provides a limited amount of control over the PMU. PMU counters 320 are utilized by the operating system or a software application to count certain processor events such as cache misses, pipeline stalls, instructions executed, etc. PMU controls 325 include registers containing various types of fields or bits for providing information about the operation of the PMU and for managing the operation of the PMU including restarting the PMU (e.g. after an overflow of a PMU counter that counts processor events). PMU controls 325 may include various control registers containing fields or bits 326 that instruct PMC 315 to freeze all counters, freeze counter n, enable/disable counting, etc. PMU controls 325 also includes status registers 327 for providing the status of certain PMU actions. Also included are event specifiers 328 for controlling the type of processor events that are counted by PMU counters 320 and the privilege states in which the events are counted.

Highly secure section 312 includes registers containing a PMU master control field 340 and a redirect interrupt (RI) field 345. PMU master control field 340 is an operating system accessible control which allows the operating system to give an application access to PMC 315, PMU counters 320, certain other PMU controls 325, as well as certain registers located in registers 360. PMU master control field 340 is a 2 bit field with four different possible values, each value indicating a certain state as follows. A value of “00” indicates that software applications are not allowed to access PM circuitry 315, PMU counters 320, or PMU controls 325. A value of “01” indicates that all PMU counters, certain PMU controls (not including event specifiers 328), and exception status registers (e.g. EBBHR 370 and EBBRR 375 described below) may be read or written by the software application. An alternative embodiment may allow the application to utilize a subset of the event specifiers, provided that the application is not allowed to utilize this subset to determine any actions by other applications, the operating system, the hypervisor, or any other entity executing on the processor. The specific PMU controls 325 that the software application may be allowed to access include controls that freeze all counters, freeze a specific counter, and re-enable the PMU 311 to begin counting after a counter overflow, or similar controls. A value of “10” indicates the same amount of application level control as state 01 except that only some of the PMU counters may be read or written by the software application. A value of “11” indicates the application can read and write all PMU counters, exception status registers, and PMU controls including event specifiers 328, but not highly secure section 312. Alternative embodiments may provide a PMU master control field of more or less than 2 bits, and thus provide additional levels of PMU control by the application than the preferred embodiment described in detail herein.

Redirect Interrupt (RI) field 325 is a single bit field that controls the handling of performance monitor exceptions (PMU exceptions). PMU exceptions are signals from the PMU that indicate that the PMU requires software intervention such as when a PMU counter overflows and needs to be reinitialized. A value of “0” indicates that PMU exceptions are not redirected to the application. In this case, PMU exceptions cause interrupts that can put the processor into a privileged state where the operating system interrupt handler can process the exception. A value of “1” indicates that performance monitor exceptions are redirected to the application. In this case, an interrupt does not occur as a result of a PMU exception, and instead an Exception Based Branch (EBB) occurs. The processor remains in problem state under the control of the software application that utilizes the PMU counters, certain PMU controls as allowed by the PMU master control field 340, and EBBHR and EBBRR as described below. The RI field may provide more than a single bit, thereby allowing redirection of PMU exceptions to multiple alternative software entities, including the hypervisor and others.

Processor 300 also includes a set of registers 360 that include an exception based branch handler register (EBBHR) 370 and an exception based branch return register (EBBRR) 375. Other registers may be located within the set of registers and the registers shown may be located elsewhere in the processor. Alternative embodiments may utilize different types of registers to implement the functionality described herein.

EBBHR 340 contains the address of the first instruction of an application level routine that processes EBBs when the RI bit equals 1 and a PMU exception occurs. When the RI bit indicates that PMU exceptions are redirected to the application, processing resumes at the address contained at this register after a PMU exception occurs. That is, when the exception occurs, hardware sets the EBBRR 345 to the address of the instruction that was executing when the PMU exception occurred. This is the address to which the application program returns in order continue normal processing after the PMU exception has been processed by the software application, preferably the application's EBB handler.

Processor 300 further includes an interrupt control 390 for generating processor interrupts when various exceptions occur such as PMU counter overflows or other events of interest. Interrupt control can receive notification of a PMU exception from PMC 315. Interrupt control 390 can also read RI field 345 to determine whether such an exception should be redirected to an application (e.g. application EBB handler) or handled as a processor interrupt.

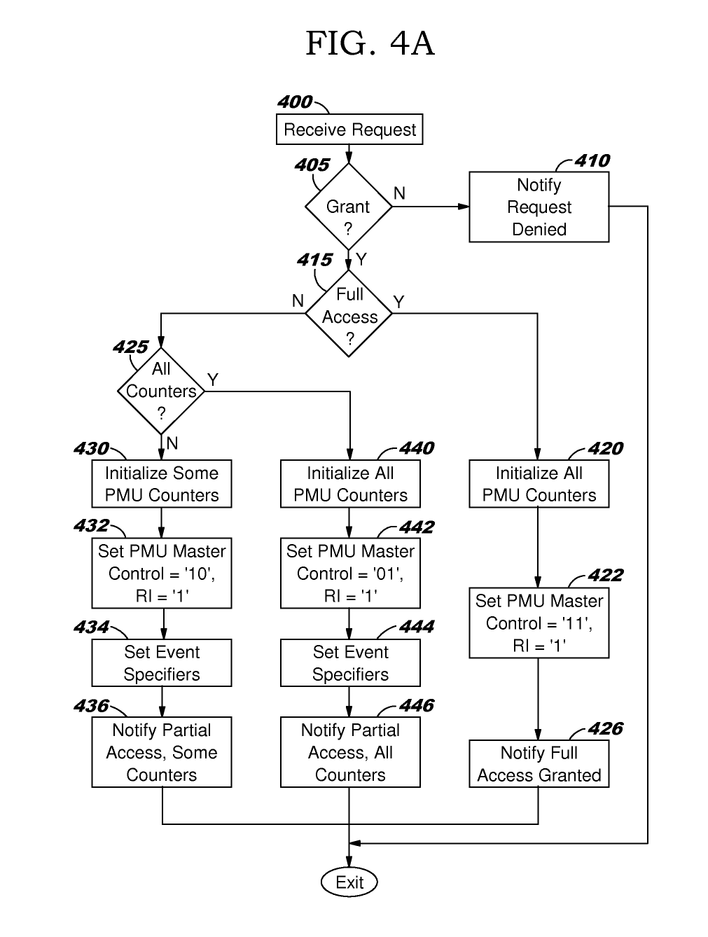

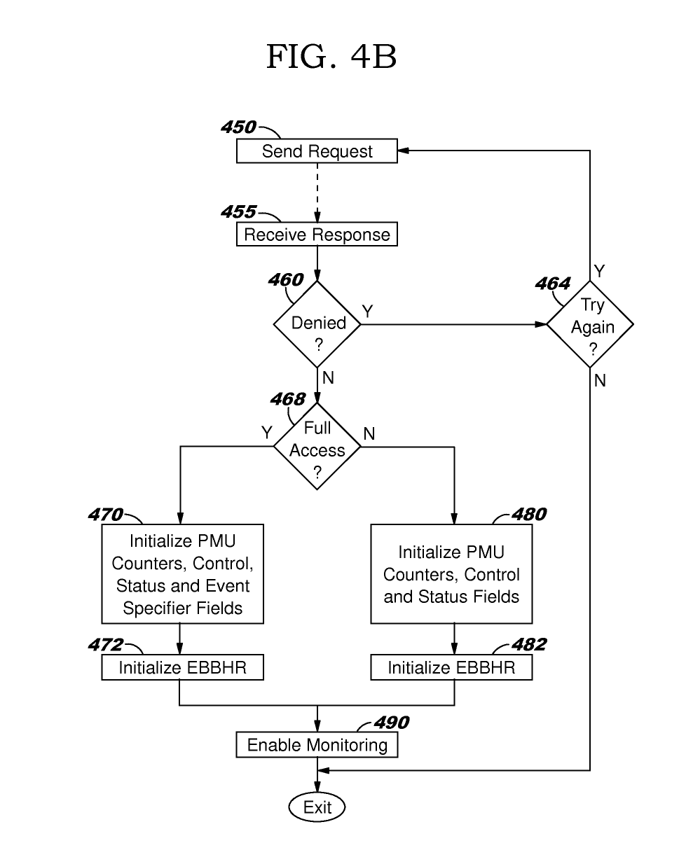

FIG. 4A is a flowchart showing the actions of an operating system in response to a request from a software application to gain access to the PMU and related counters and registers in accordance with a preferred embodiment. Although a second operating system executing on processor 300 may exist, use of the performance monitor is typically limited to a single operating system at a time by a hypervisor which would typically control many other security and access issues not related to these embodiments.

In a first step 400, the operating system receives a request from a software application to access the PMU. The request may specify whether the software application requests partial or full access to the PMU. The request may also specify the number of PMU counters that the software application wants to access. Alternative embodiments may allow the application to request access to other specific parts of the PMU such as controls over when counters count, heat sensors, etc. In a second step 405, the operating system determines whether to grant the request. Various reasons may prompt the operating system to deny the request such as another software application may be already accessing the PMU. If denied, then in step 410 notice of the denial is sent to the requesting software application.

If access is granted in step 405, then in step 415 the operating system determines whether full or partial access should be granted. Only special applications such as field debug analysis tools would typically ever be given full access, and then only in secure environments in which the user is trusted not to access unauthorized data (e.g. when an IT team goes to customer site to fix a problem). With full access, the application can read and write event specifiers 328, thereby modifying which processor events are counted by the PMU. With this level of control, the application may be able to view actions and/or events caused by other applications, the hypervisor, or the operating system, which is a potential security risk. If full access is granted in step 415, then in step 420 all PMU controls 325 and counters 320 are initialized to remove any evidence of prior PMU activity for security purposes. Subsequently, in step 422, the PMU master control field 340 is set to “11” and the RI field is set to “1”, thereby allowing the requesting software application to access the PMU and all related counters and registers except for the highly-secure section 312. Because the application is trusted enough to grant it full access to the PMU, there is not a need to initialize the event specifiers. However, alternative embodiments may allow for such a step. Then in step 426 the operating system notifies the software application that full access to the PMU and related counters and registers has been completed. That is, the software application is notified that all control of the PMU is given to the application and there is no operating system involvement until either the operating system revokes control or the software application relinquishes it.

If partial access is granted in step 415, then in step 425 it is determined whether the application will be granted access to all PMU counters or not. An application may or may not request all counters, and if not all counters are requested then certain counters may be utilized by the operating system. If access is not granted to all PMU counters, then in 430 the PMU counters which the software application may access are initialized to remove any evidence of prior PMU activity for security purposes. Subsequently, in step 432, the PMU control field is set to “10” to give the application access to a subset of the PMU counters 320 and PMU controls 325 (not including event specifiers 328). Also, the RI field is set to “1”, thereby redirecting any PMU exceptions to the application and allowing it to access the EBB registers 370 and 375. In step 434, the event specifiers for each counter is set by the operating system to count the events requested by the application. Then in step 436 the operating system notifies the software application that the counters have been configured to count the requested events and access to the selected counters and registers has been provided until relinquished by the software application or revoked by the operating system.

If access is granted to all PMU counters in step 425, then in 440 the all PMU counters are initialized to remove any evidence of prior PMU activity for security purposes. Subsequently, in step 442, the PMU control field is set to “01” give the application access to all the PMU counters 320 and a subset of the PMU controls 325 (not including event specifiers 328). Also, the RI field is set to “1”, thereby redirecting any PMU exceptions to the application and allowing it to access the EBB registers 370 and 375. In step 444, the event specifiers for each counter is set by the operating system to count the events requested by the application. Then in step 446 the operating system notifies the software application that access to all the PMU counters and registers has been provided until relinquished by the software application or revoked by the operating system.

FIG. 4B is a flowchart showing the actions of a software application requesting access to the PMU and related counters and registers in accordance with the preferred embodiment. In a first step 450, the software application sends a request to the operating system requesting access to the PMU and related counters and registers. The request indicates whether or not full or partial access is requested, and if partial access was indicated, the request also indicates the events to be counted by each counter. In step 455, a response is received from the operating system regarding the request. In step 460, it is determined whether the response indicates the request was denied by the operating system. If yes, then in step 464, the application software determines whether to perform the request again. The subsequent requests need not be identical to the first request. For example, if the first request was for partial PMU access to all PMU counters, then the subsequent request may be for partial access to only a subset of the counters, and vice versa. Other variations are possible. If yes, the processing returns to step 450. If not, then the software application may pursue other alternative solutions such as communicating directly with the operating system regarding performance related data.

If the request was approved by the operating system, then step 468 distinguishes whether the request was for full access or partial access. If the request was for full access, then in step 470 the software application can reinitialize all the PMU counters and PMU controls (control fields, event specifiers, etc.) as desired. For example, a PMU counter may be set to a non-zero number to generate a counter overflow (i.e. a PMU exception) at a predetermined number of events counted by that counter. For another example, the event specifiers may be modified by the application to track certain processor events. In step 472, the application initializes the EBBHR register to the address of the software application's EBB handler that processes redirected performance monitor exceptions. Subsequently, in step 490 the performance monitor is enabled by the application writing a specific value to one of the PMU control fields 326. This indicates to the performance monitor that all counters and registers have been initialized and that monitoring can proceed.

If partial access was granted in step 468, then in step 480 the software application can initialize the PMU counters and PMU control fields it has access to, not including event specifiers 328. Each of these accessed fields are reinitialized to their desired values. For example, a PMU counter may be set to a non-zero number to generate a counter overflow (i.e. a PMU exception) at a predetermined number of events counted by that counter. In step 482, the application also initializes the EBBHR register to the address of the software application's EBB handler that processes redirected performance monitor interrupts. Subsequently, in step 490, the performance monitor is enabled by the application writing a specific value to one of the PMU control fields 326. This indicates to the performance monitor that all counters and registers have been initialized and that monitoring can proceed.

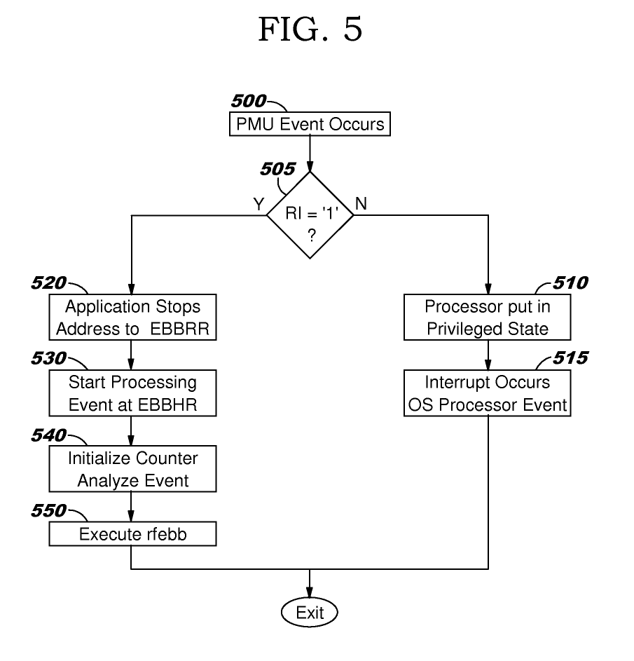

FIG. 5 is a flowchart of the handling of a performance monitor exception (e.g. PMU counter overflow) in accordance with the preferred embodiment. In a first step the performance monitor exception occurs and is detected by the PM circuitry which notifies interrupt control 390. In a second step 505, the interrupt control reads the redirect interrupt (RI) field to determine how the exception should be handled. If the RI bit is equal to zero, then processing proceeds to step 510 where interrupt control 390 causes the processor to enter into a privileged state. Subsequently, in step 515 an interrupt occurs, at which point the operating system processes the performance monitor event.

If the RI is equal to one, then in step 520 processing of the software application is interrupted by interrupt control 390 and the address of the software application instruction at the point of the exception is saved in the EBBRR register. Subsequently, in step 530, processing continues at the address indicated in the EBBHR where the exception is handled by the software application, preferably an EBB handler of the software application. Such an EBB handler would reinitialize the counter that overflowed, possibly change the event specifiers if full control was granted, and perform any actions necessary to analyze the event in step 540. In step 550, once the analysis has been completed, the application re-enables the PMU for counting and executes a branch instruction to return to the point in the application where the exception occurred (i.e. the address contained in the EBBRR). The re-enabling of the PMU and branch can be performed by executing a “return from EBB” or rfebb instruction if such an instruction is provided by the implementation, or it can be performed by writing to a PMU control that enables the PMU to count, and subsequently executing a “branch” instruction to the address contained in the EBBRR.

The invention can take the form of an entirely software embodiment, or an embodiment containing both hardware and software elements. In an embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such code for processing exception based branches. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for an operating system (OS) enabling an application direct control of a performance monitoring unit (PMU) comprising:
enabling the PMU to notify the application when a PMU exception occurs without interrupting the OS by controllably encoding a redirect field in an OS accessible control register; and
enabling the application to directly reinitialize the PMU after the PMU exception.

2. The method of claim 1 wherein the OS enables the application to reinitialize the PMU by controllably encoding a PMU control field in the OS accessible control register.

3. The method of claim 1 wherein the PMU includes a plurality of PMU counters for counting processor events.

4. The method of claim 3 wherein the PMU exception is an overflow of one of said PMU counters.

5. The method of claim 4 wherein the application is given direct access to a portion of the PMU counters.

6. The method of claim 5 wherein the application initializes the portion of PMU counters to desired values without communicating with the OS.

7. The method of claim 3 wherein the application is given write access to an event specifier that controls which processor events are counted by one of the PMU counters.

8. The method of claim 2 wherein the PMU includes a plurality of PMU counters for counting processor events, wherein the PMU exception is an overflow of one of said PMU counters, wherein the application is given direct access to a portion of the PMU counters, wherein the application initializes the portion of PMU counters to desired values without communicating with the OS, and wherein the application is given write access to an event specifier that controls which processor events are counted by one of the PMU counters.

9. A system for an operating system (OS) enabling an application direct control of a performance monitoring unit (PMU) comprising:
a redirect field in an OS accessible control register that is controllably encoded to enable the PMU to notify the application when a PMU exception occurs without interrupting the OS; and
a PMU control field in the OS accessible control register, wherein the OS controllably encodes the PMU control field to enable the application to directly reinitialize the PMU after the PMU exception.

10. The system of claim 9 wherein the PMU includes a plurality of counters for counting processor events.

11. The system of claim 10 wherein the PMU exception is an overflow of one of said PMU counters.

12. The system of claim 11 wherein the application is given direct access to a portion of the PMU counters.

13. The system of claim 10 wherein the application initializes the portion of the PMU counters to desired values without communicating with the OS.

14. The method of claim 10 wherein the application is given write access to an event specifier that controls which processor events are counted by one of the PMU counters.

15. A data processing system for an operating system (OS) enabling an application direct control of a performance monitoring unit (PMU), the data processing system comprising:
a processor; and
a memory storing program instructions which when executed by the processor execute the steps of:
enabling the PMU to notify the application when a PMU exception occurs without interrupting the OS; and
enabling the application to directly reinitialize the PMU after the PMU exception.

16. The data processing system of claim 15 wherein the OS enables the PMU to notify the application when the PMU exception occurs by controllably encoding a redirect field in an OS accessible control register.

17. The data processing system of claim 16 wherein the OS enables the application to reinitialize the PMU by controllably encoding a PMU control field in the OS accessible control register.

18. The data processing system of claim 15 wherein the PMU includes a plurality of PMU counters for counting processor events.

19. The data processing system of claim 18 wherein the PMU exception is an overflow of one of said PMU counters.

20. The data processing system of claim 19 wherein the application is given direct access to a portion of the PMU counters.

21. The data processing system of claim 20 wherein the application initializes the portion of PMU counters to desired values without communicating with the OS.

22. A computer usable program product comprising a computer usable storage medium including computer usable code for an operating system (OS) enabling an application direct control of a performance monitoring unit (PMU), the computer usable program product comprising code for performing the steps of:
enabling the PMU to notify the application when a PMU exception occurs without interrupting the OS by controllably encoding a redirect field in an OS accessible control register; and
enabling the application to directly reinitialize the PMU after the PMU exception.

23. The computer usable program product of claim 22 wherein the OS enables the application to reinitialize the PMU by controllably encoding a PMU control field in the OS accessible control register.
